(19) United States
(12) Patent Application Publication
(10) Pub. No.: US 2016/0148163 A1
(43) Pub. Date: May 26, 2016

(54) REPRESENTING IN AN ELECTRONIC CALENDAR TRAVEL TIME TO AND FROM AN EVENT

(71) Applicant: Lenovo (Singapore) Pte. Ltd., New Tech Park (SG)

(72) Inventors: Suzanne Marion Beaumont, Wake Forest, NC (US); Rod D. Waltermann, Rougemont, NC (US); Grigori Zaitsev, Durham, NC (US)

(21) Appl. No.: 14/549,187

(22) Filed: Nov. 20, 2014

(51) Int. Cl. G06Q 10/10

(52) U.S. Cl. CPC G06Q 10/1095

(57) ABSTRACT

In one aspect, a device includes a processor and a memory accessible to the processor. The memory bears instructions executable by the processor to predict a time to travel at least one of to an event entered in an electronic calendar and from the event indicated in the electronic calendar. The instructions are also executable to represent the time to travel in the electronic calendar.

### I. FIELD

The present application relates generally to representing in an electronic calendar travel time to and/or from an event.

### II. BACKGROUND

Typically a user manually enters events into an electronic calendar (e.g. “blocking off” time for the event). However, the time blocked off often does not account for other scheduling factors unless the user also remembers to account for them, which can be burdensome and cause scheduling conflicts when forgotten.

### SUMMARY

Accordingly, in one aspect a device includes a processor and a memory accessible to the processor. The memory bears instructions executable by the processor to establish a first entry in an electronic calendar for a first event based on a first date and a first time and determine, based at least partially on the first date and the first time, a second date and a second time during which a second entry in the electronic calendar pertaining to an in-person meeting cannot be established.

In another aspect, a method includes estimating time to travel at least one of to an event entered in an electronic calendar and from the event indicated in the electronic calendar, and representing the time to travel in the electronic calendar.

In still another aspect, a computer readable storage medium that is not a carrier wave includes instructions executable by a processor to identify information pertaining to a transit time at least one of to an event indicated in an electronic calendar and from the event indicated in the electronic calendar, and indicate in the electronic calendar the information.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart showing an example algorithm in accordance with present principles;

FIGS. 4-7 are example user interfaces (UI) in accordance with present principles; and

FIG. 8 is an example data table in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone. B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together. A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

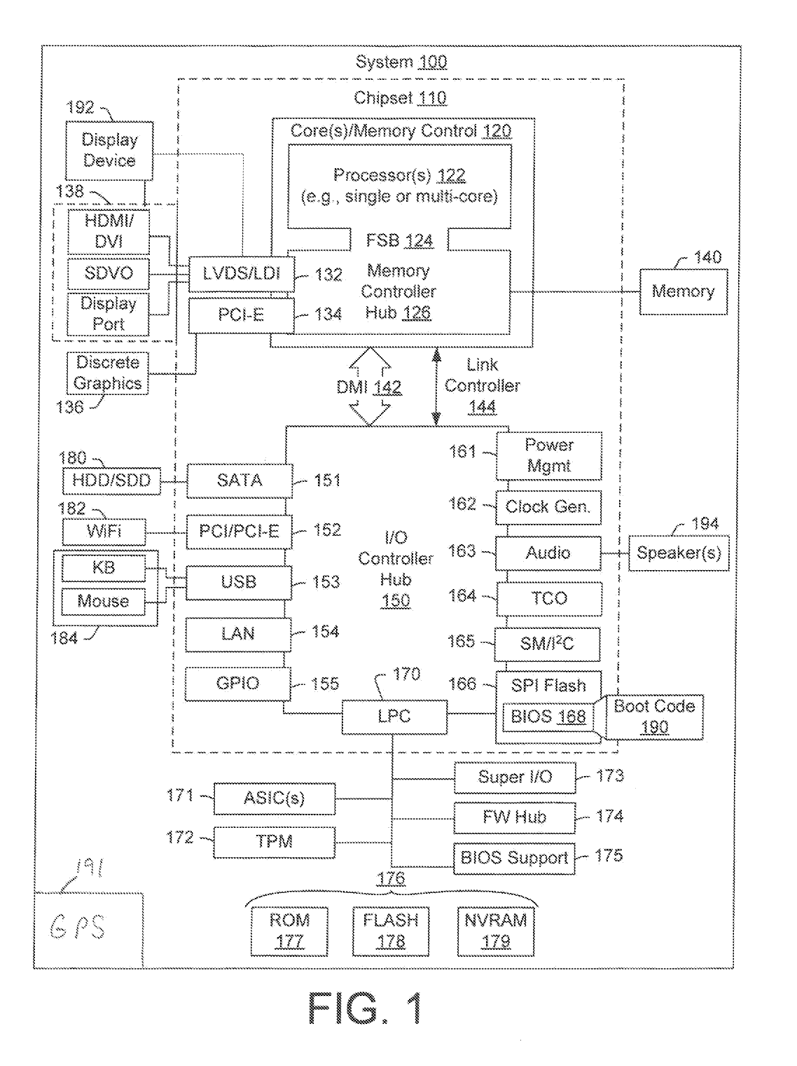

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX®, or Playstation®.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Still in reference to FIG. 1, the system 100 may include a GPS transceiver 191 that is configured to e.g. receive geographic position information from at least one satellite and provide the information to the processor 122. However, it is to be understood that another suitable position receiver other than a GPS receiver may be used in accordance with present principles to e.g. determine the location of the system 100.

Additionally, and though now shown for clarity, in some embodiments the system 100 may include a gyroscope for e.g. sensing and/or measuring the orientation of the system 100 and providing input related thereto to the processor 122, an accelerometer for e.g. sensing acceleration and/or movement of the system 100 and providing input related thereto to the processor 122, an audio receiver/microphone providing input to the processor 122 e.g. based on a user providing audible input to the microphone, and a camera for gathering one or more images and providing input related thereto to the processor 122. The camera may be, e.g., a thermal imaging camera, a digital camera such as a webcam, and/or a camera integrated into the system 100 and controllable by the processor 122 to gather pictures/images and/or video.

Also not shown for clarity, the system 100 may include still other sensors for undertaking present principles, such as e.g. biometric sensors to identify user activity and biometrics (e.g., sitting, walking, heart rate, etc.), as well as sensors for sensing environmental factors for both interior and exterior spaces (e.g. temperature sensors, ambient light sensors, etc.).

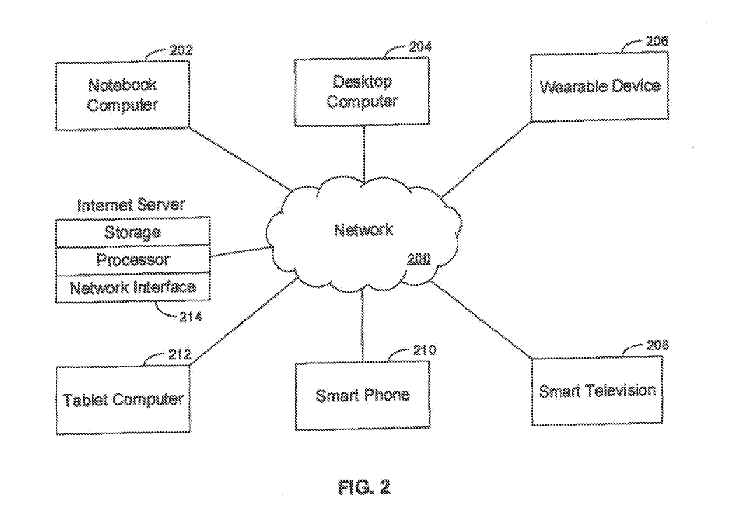

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 (such as e.g. a smart watch, a smart bracelet, a fitness monitoring device, a biometric monitoring device, a sleep monitoring device, for gathering data about a user of the device 206 in accordance with present principles etc.), a smart television (TV) 208, a smart phone 210, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

It is to also be understood that one or more of the devices shown in FIG. 2 may be associated with a single user, such as the user of an electronic calendar as described herein. Notwithstanding, it is to be further understood that at least some of the devices shown in FIG. 2 may be associated with different users to thus provide “crowd sourcing” of data (such as e.g. environmental factors like temperature) for undertaking present principles.

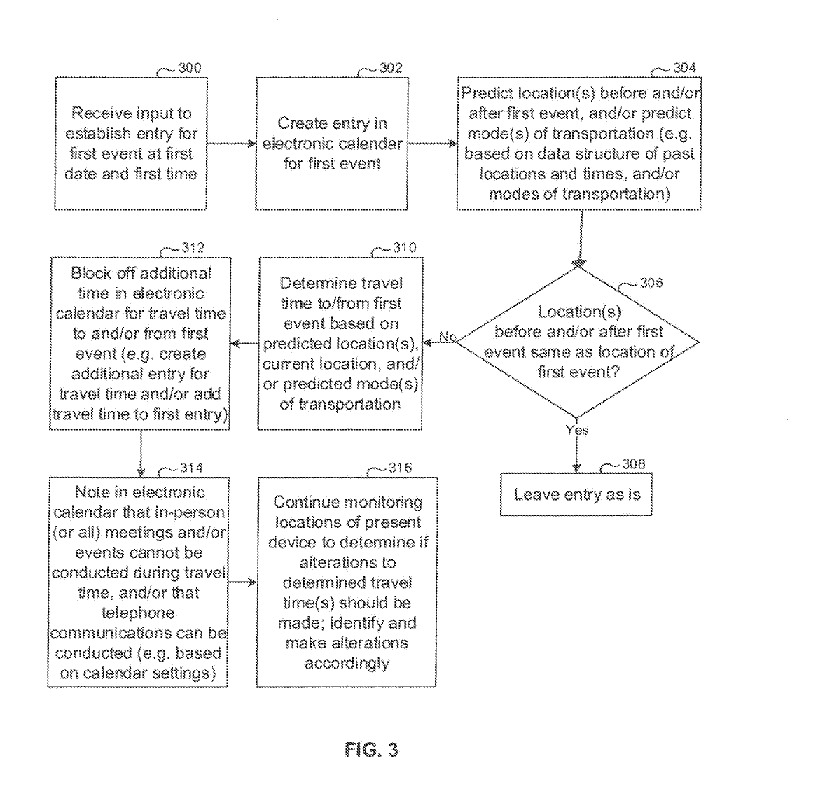

Referring to FIG. 3, it shows example logic that may be undertaken by a device such as the system 100 in accordance with present principles. A device undertaking the logic of FIG. 3 will be referred to below as the “present device” for simplicity. Beginning at block 300, the logic receives input to establish an entry in an electronic calendar for a first event which is to occur at a first date and a first time. The logic then proceeds to block 302, where the logic creates an entry in the electronic calendar for the first event based on and/or in response to the input received at block 300.

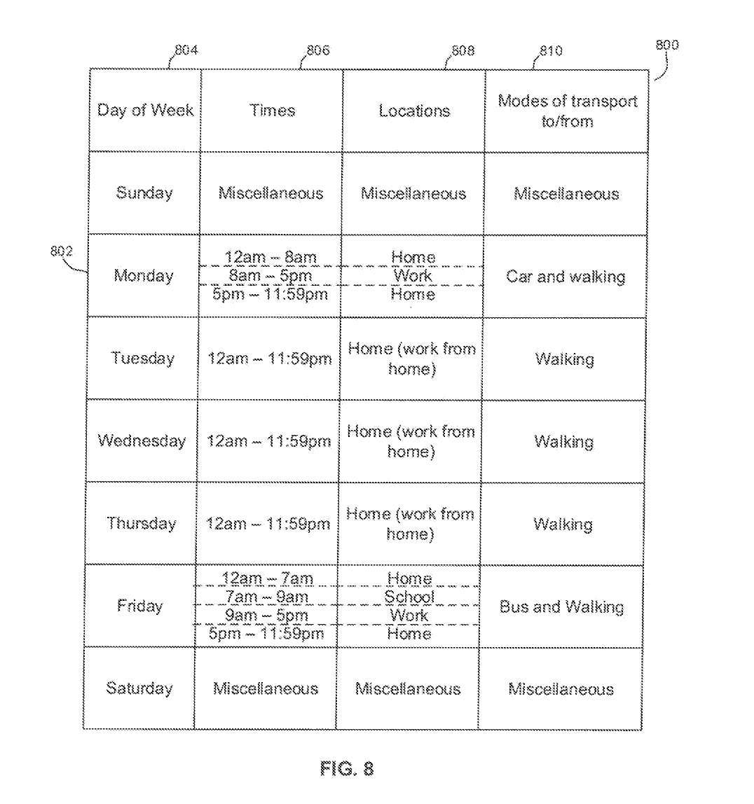

After block 302 the logic moves to block 304. At block 304 the logic predicts one or more locations at which the present device and/or user (of the present device and/or associated with the electronic calendar) will be located before the first event and/or after the first event (e.g. generally, immediately before and immediately after, and/or for threshold times before and threshold times after). Also at block 304 the logic may predict one or more modes of transportation that the user will use to travel. The prediction(s) made at block 304 may be made at least in part based on data in a data table accessible to the present device. An example data table that may be used in accordance with present principles will be discussed further below in reference to FIG. 8.

Still in reference to FIG. 3, after block 304 the logic moves to decision diamond 306. At diamond 306 the logic determines whether the location(s) predicted at block 304 for where the device and/or user will be before and after the first event are the same location as the location of the first event itself. E.g., the locations before and after the first event, as well as the location of the first event, may be a building in which the user works. An affirmative determination at diamond 306 causes the logic to move to block 308, at which the logic takes no additional action relating to the entry for the first event in the electronic calendar.

However, a negative determination at diamond 306 instead causes the logic to proceed to block 310, at which the logic determines travel time to and/or from the location of the first event based on the location(s) predicted at block 304. Thus, also at block 310, the logic may determine travel time to and/or from the location of the first event based on a current location of the present device and/or user (e.g. if the logic executes what is described in reference to block 310 at a time right before or right after the time of the first event) and/or the predicted mode(s) of transportation.

After block 310 the logic proceeds to block 312. At block 312 the logic may block off, create an entry, and/or otherwise reserve time in the electronic calendar before and/or after the first event for the respective travel times to and/or from the location of the first event. In some embodiments, the logic may reserve the time by amending the first entry as represented in the electronic calendar to indicate that the time range for first event includes the travel time. Also in some embodiments, the logic may create a new entry for the travel time.

After block 312 the logic moves to block 314, where the logic may indicate in the electronic calendar that e.g. in-person (or all) meetings and/or events cannot be conducted during the travel time so that e.g. another person accessing the electronic calendar to ascertain the availability of the user of the electronic calendar may upon viewing the user's electronic calendar determine that the user is not available during the travel time for a meeting. Also in some embodiments, the logic may indicate in the electronic calendar at block 314 that e.g. telephone communications can be conducted during the travel time. The logic may do so e.g. based on user settings for the electronic calendar regarding whether the user wishes to engage in telephone communications while traveling.

After block 314 the logic proceeds to block 316 where the logic continues monitoring the location(s) of the present device to determine if (e.g. based on a current location) alterations to the determined travel times and hence their corresponding entries in the electronic calendar should be made (e.g. if one of the predictions discussed above is determined to not be precise based on a condition that has changed). Upon identification of any such alterations to make, the logic may make such alterations accordingly, also at block 316.

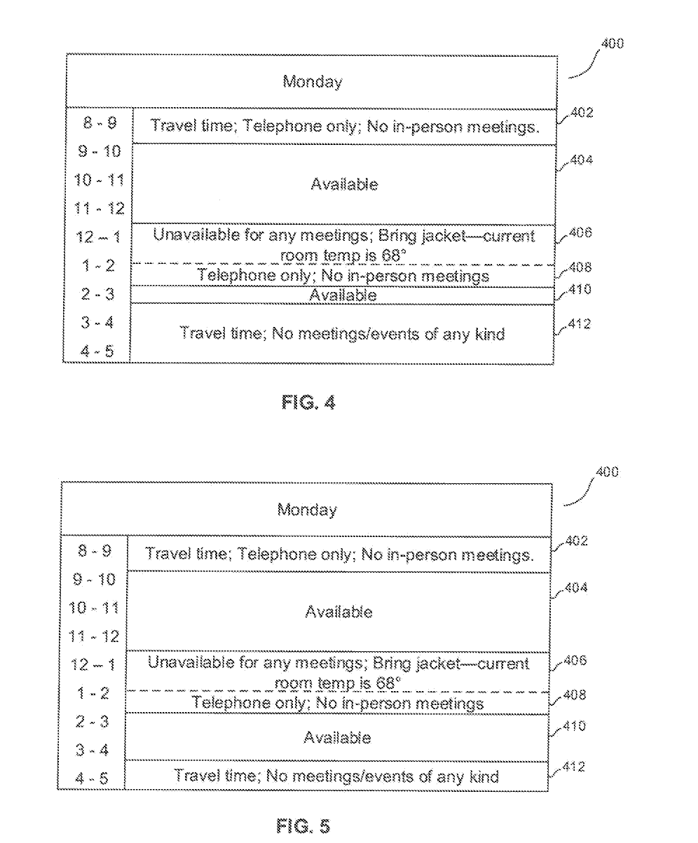

Continuing the detailed description now in reference to FIG. 4, it shows an example representation 400 of an electronic calendar that may be presented on a display of a device such as the device undertaking the logic of FIG. 3 and/or a device of a person wishing to ascertain the availability of a user associated with the electronic calendar by accessing the user's electronic calendar from the other person's device. In some embodiments, the representation 400 may be a user interface (UI) at which the user and/or another person may manipulate the electronic calendar via the UI (e.g. by selecting a particular area of the representation 400 to create an entry at a time corresponding to the area selected).

In any case, as may be appreciated from FIG. 4, the representation 400 includes a first entry 402 from 8:00 am. to 9:00 a.m. which is indicated in the electronic calendar as being travel time. Also note that the entry 402 indicates that the user of the electronic calendar is available for telephone communication but not for in-person meetings. A second entry 404 is also shown, but note that the entry merely indicates that the user is available from 9:00 a.m. to 12:00 p.m.

An entry 406 from 12:00 p.m. to 2:00 p.m. indicates that the user is unavailable for meetings. Entry 406 also indicates that the user should bring a jacket because the current room temperature in the room in which an event blocked off from 12:00 p.m. to 2:00 p.m. is to take place is currently sixty eight degrees (e.g. which may have been determined based on real-time data such as may have been received via a communication from another device already at the room that has gathered a temperature reading for the room). It is to be understood that in some embodiments, the user when accessing their calendar may view the indication regarding the jacket, but another person accessing the user's calendar at another device to ascertain the user's availability may not be able to see the jacket indication (e.g. based on the information being tagged for viewing by the user only and/or based on other calendar and/or event viewing permissions for the user versus other people). Still in reference to the entry 406, the entry 406 itself includes another portion 408 from 1:00 to 2:00 p.m. indicating that the user is available for telephone communications but not for in-person meetings. It may thus be appreciated that the entry 406 has had an addition thereto for travel time between 1:00 to 2:00 p.m. (e.g. even if the representation 400 does not explicitly indicate it as being such).

Still in reference to FIG. 4, the representation 400 also includes yet another entry 410, which indicates that the user is available from 2:00 p.m. to 4:00 p.m. Last, an entry 412 is shown in which it is explicitly indicated that the window of time between 4:00 p.m. and 5:00 p.m. is a time during which the user will be traveling (e.g. based on a prediction of travel time as discussed herein). The entry 412 also indicates that the user is unavailable for meetings or events of any kind (e.g. telephone communications, in-person meetings, etc.), which may be viewable by others observing the user's calendar.

Now in reference to FIG. 5, the representation 400 is again shown. However, note that the entry 412 now indicates that the user is unavailable for meetings or events of any kind from 3:00 p.m. to 5:00 p.m. It is to be understood that the change in the entry 412 may have been altered based on e.g. a user's current location and/or based on a change to a prediction for the user's travel time and/or a location to travel to or from. Thus, it is to be understood that in some embodiments, the alteration to the entry 412 as shown in FIG. 5 may have occurred such as e.g. at block 316 of FIG. 3.

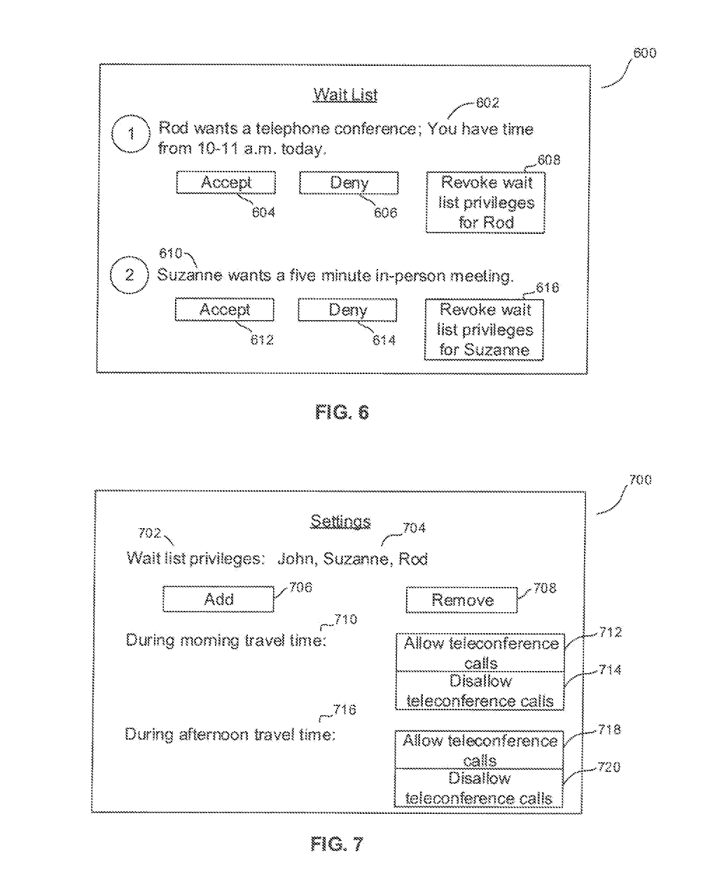

Continuing the detailed description in reference to FIG. 6, it shows an example user interface (UI) 600 with may be presented on the display of a device such as the system 100 in accordance with present principles. The UI 600 comprises at least one indication 602 of a request (e.g. a “wait list” request) for an appointment with a user (e.g. that may upon acceptance be entered to the user's electronic calendar and which may have been submitted by another person using another device which can access the user's electronic calendar to submit a meeting request for wait listing). Note that the indication 602 includes the name of the person requesting the appointment, along with the type of appointment requested. In this case, a person named Rod has requested a telephone conference with the user of the electronic calendar. Also note that the indication 602 includes information pertaining to an available time slot in the electronic calendar e.g. as determined automatically by the device on which the UI 600 is presented and/or the use's electronic calendar. In this example, the indication 602 contains information that the user, e.g. based on data from the electronic calendar, has a time slot available from 10:00 a.m. to 11:00 a.m. today.

Accompanying the indication 602 is an accept selector element 604 and a deny selector element 606. The select selector element 604 is selectable to automatically without further user input create an entry in the electronic calendar for a telephone conference with Rod at the time requested (e.g. by Rod) and/or indicated (e.g. by the electronic calendar), and may also be selectable to automatically without further user input e.g. send a confirmation message to the device at which Rod provided the request and/or a messaging account associated with Rod (e.g. an email account). Furthermore, the selector element 604 may in some embodiments also be selectable to automatically without further user input e.g. create an entry in Rod's electronic calendar for the telephone conference from 10:00 a.m. to 11:00 a.m. Thus, it is to be understood that in some embodiments, electronic calendars of respective users may be linked and/or otherwise be configured to share information.

As mentioned above, a deny selector element 606 is also shown for the indication 602. The deny selector element 606 is selectable to automatically without further user input deny the request. In some embodiments, selection of the element 606 may e.g. remove the request from the UI 600 and/or delete the request altogether, while in other embodiments selection of the element 606 may e.g. deny the request from being entered in the user's electronic calendar at the time slot indicated but e.g. not remove the request from the UI 600 (e.g. as represented by the indication 602), but instead e.g. revise the indication 602 to indicate another time slot from the user's calendar determined by the calendar to be available for the event. Whether to remove the request from the UI 600 or indicate another time based on selection of the element 606 may be e.g. determined based on user input.

Still further, included with the indication 602 is a selector element 608 which is selectable to automatically without further user input revoke wait list privileges for the user that initiated the request (e.g. in this case. Rod) so that the user cannot subsequently submit additional requests for appointments with the user and/or creation of entries in the user's electronic calendar (e.g. without further user input again allowing the person to submit requests) and hence disallow the person from creating additional entries in a “wait list” UI such as the one shown in FIG. 6. In some embodiments, selection of the element 608 may also deny the current request as indicated above.

The UI 600 includes another indication 610 for another example request. Note that the indication 610 does not include a recommended time to conduct an in-person meeting with Suzanne, but does indicate an amount of time Suzanne indicated the meeting would take to complete. Accompanying the indication 610 is an accept selector element 612, deny selector element 614, and revocation of wait list privileges 616 which are respectively selectable to undertake functions similar to those described above with respect to the elements 604, 606, and 608, mutatis mutandis.

Now in reference to FIG. 7, it shows an example UI 700 for configuring settings of an application and/or device undertaking present principles. The UI 700 includes at least a first setting 702 for wait list privileges for requesting an appointment with a user of an electronic calendar. The setting 702 indicates that, in the present example, the people John, Suzanne, and Rod currently have wait list privileges to request appointments based on data in the user's electronic calendar. The setting 702 also has an add selector element 706 associated therewith, which is selectable to e.g. present an overlay window and/or another UI for selecting and adding other people to be permitted to request wait list appointments. The setting 702 further includes a remove selector element 708 which is selectable to e.g. present an overlay window and/or another UI for selecting and removing people from being permitted to request appointments.

The UI 700 of FIG. 7 also includes at least one setting 710 for what information to show to others and/or permissions for others should be allowed during a particular travel time that e.g. is recurring and/or predicted to recur, such as e.g. traveling to work in the morning and from work in the afternoon. Thus, the setting 710 in the present example pertains to morning travel time, and selector element 712 is associated therewith and is selectable to configure the user's electronic calendar to indicate that telephone calls are allowed during the user's morning commute and to permit other people to set telephone events in the user's electronic calendar accordingly. A selector element 714 is also associated with the setting 710 and is selectable to configure the user's electronic calendar to indicate that telephone calls are not allowed during the user's morning commute and to prohibit other people from setting telephone events in the user's electronic calendar accordingly.

Note that the UI 700 also includes another setting 716 pertaining to the user's afternoon travel time. The setting also includes selector elements 718 and 720, which are respectively selectable to undertake functions similar to the elements 712 and 714, mutatis mutandis.

Continuing now in reference to FIG. 8, it shows an example data table 800 that may be accessed by a device for undertaking present principles. The data table 800 may be used to e.g. predict available times and travel times for an event that may then be noted in an electronic calendar associated with a user, along with e.g. locations at particular times and modes of transportation used to and from certain locations and/or at certain times. Taking entry 802 as an example, a device undertaking present principles may determine a day of the week for which a prediction is to be made, access the table 800 and locate a day of the week in column 804 matching the determined day of the week.

Once a match has been made (in this case, Monday), the device may proceed to the information noted in column 806 for entry 802 to identify one or more time ranges and/or blocks of time which are associated with respective locations in column 808 at which the user and/or device associated with the user has been at least one previous time on the associated day of the week. Thus, in the present example, it may be appreciated from entry 802 that data has been entered to the table 800 that on Mondays, from e.g. 12:00 a.m. to 8:00 a.m. the user is at their home, while from 8:00 a.m. to 5:00 p.m. they are at work, and then from 5:00 p.m. to 11:59 p.m. they are home again. Also note that modes of transportation are indicated in column 810, and thus a device accessing the table 800 in accordance with present principles may e.g. locate the entry 802 and then identify modes of transportation from column 810 for entry 802 to thus predict one or more modes of transportation that are likely to be used in the future e.g. under similar circumstances (e.g. a Monday afternoon commute from the same location).

Still in reference to FIG. 8, it is to be understood that the example data table 800 may have been created, had data entered thereto, and/or be amended by a device undertaking present principles so that e.g. future predictions can be made and even be more accurate than previous ones. For example, based on GPS data that the device receives (e.g. from a GPS transceiver on the device), the device may determine a location of the user's device and hence the user, identify a time or time span at which the user is at the location, and then enter into the data table corresponding times in column 806 for an entry and corresponding locations in column 808 for the entry. Also note that the data indicated in such a data table may in some embodiments be e.g. data averages for multiple same days of the week (e.g. multiple Mondays) so that the average may change as time goes on. Notwithstanding, in addition to or in lieu of the foregoing, an entry for such a data table indicate separate data for multiple same days of the week.

Without reference to any particular figure, it is to be understood that e.g. a person wishing to create a wait list request for an appointment with a user based on the user's schedule (e.g. as indicated in the user's electronic calendar) may be presented with a UI including various input fields for inputting information including e.g. the person's name and company affiliation, the class or type of appointment (e.g. in-person, meeting, etc.), and the desired length of the appointment with the user. Upon completion of inputting information into such a UI, the information may be transmitted to the user's device and/or electronic calendar for e.g. presentation on a wait list UI such as the UI 600 described above.

Further, it is to be understood that while some of the present disclosure refers to telephonic communication (e.g. over a cellular networking, VOIP, etc.) as an alternative to an in-person meeting, still other alternatives to in-person meetings may be used e.g. during travel time in accordance with present principles. For instance, holographic communication and/or disembodied smart avatars may be used, as may video conferencing. Accordingly, electronic calendars undertaking present principles may indicate these things in a time blocked off for travel time, and furthermore requests for these alternatives may be submitted for “wait listing” as described herein as well. What's more, it is to be understood that an electronic calendar may interface with a user's environment such as e.g. an on-board computer of a motor vehicle to ascertain the availability of such alternatives (e.g. video conferencing and/or the ability to present holographic representations of other people with whom the user is communicating).

Also without reference to any particular figure, it is to be understood that a calendar application and/or its associated data may be stored e.g. via a cloud service, locally on a particular device, on a server, and/or another location accessible devices over a network such as the Internet.

Also, note that data tables that may be accessed for undertaking present principles, such as the table 800 described above (e.g. and even a calendar entry itself) may be created and/or revised based on data and/or commands input from e.g. plural devices with which a single user is associated and which all have access to the data tables and calendars. Thus, e.g. information and context may be determine and/or gathered from a user's smart phone, tablet computer, and work computer and synthesized in a data table and/or calendar.

It may now be appreciated that present principles provide for e.g., based on the location of activities entered in an electronic calendar, and the calendar's and/or a device's “knowledge” of where the user will be prior to and after an activity, blocking off time on the user's calendar to represent travel time. Contextual computing outputs may be used, such as e.g. knowledge of the user's typical day (e.g. based on day of the week, a collection of already scheduled events, and/or the user's past history), knowledge of location (e.g. both where the user is currently and associating geo-location with scheduled events), and typical mode of transport (e.g. based on day of the week, the collection of already scheduled events, and/or the user's past history).

Real-time adjustments to the calendar may also be made. E.g., the calendar may be flexible so that if assumptions and/or predictions that are made about where the user will be prior to an appointment are not correct, then the calendar may auto-adjust. For example, if a user has an event at her child's school mid-afternoon on a Wednesday, then her calendar could assume that she would travel from work to school (e.g. 14.5 miles) and block her schedule for that travel time. However, if she chose to work from home that day, then the calendar could readjust for the travel time from home to school (e.g. 20 miles).

Furthermore, electronic calendars in accordance with present principles may collaborate with peer applications as well (e.g. personal assistants). For example, the calendar may work with peer applications so that if an invitation is sent based on perceived and/or indicated free time, but the peer application determines (e.g. after considering travel time) that some less time is actually available, then a message from the calendar application may include different kinds of acceptance such as “accept, but will be late by X minutes,” and/or “accept but push start time out by X minutes.” and/or “accept but pull in end time by X minutes.”

What's more, different kinds of indications of “busy” time and “free” time in the calendar may be used. For example, the calendar can identify different types of schedule items, like “travel time” and/or “meeting time.” For the user, “travel time” can still be useful, and the calendar may allow for the scheduling of certain types of activities “on top” of that “busy” period and/or indicate e.g. “phone only” during that time. However, to someone trying to schedule an in-person meeting with the user at that time, they may see the “travel time” as busy time during which the user is unavailable (e.g. for any type of event).

Moreover, an electronic calendar and/or device undertaking present principles may leverage crowd sourced “micro-knowledge.” For example, the calendar may leverage knowledge of a building's layout to offer micro-navigation tips for when a user attends a meeting there, as well as computing scheduling impacts. Thus, e.g., when traveling to new locations where specific buildings/meeting rooms are not known by the user, crowd-sourcing of data from other devices may be used. More specifically, this “knowledge” may be gained by “crowd sourcing” sensor output from all devices present or transient through the location to create a site map. GPS transceivers and/or other sensors, as well as dead reckoning, may be used for such purposes (e.g. to identify for pathways within a building) as well. A source of blueprints may also be accessed to get building layout information. The calendar may then e.g. building a sitemap from contextual data and even e.g. present a representation of the site map which indicates the contextual data.

A calendar in accordance with present principles may also leverage knowledge sourced from another device's sensors (e.g. temperature sensors) that have been where the user is going to offer preparedness advice for the appointment (e.g. in a custom message (e.g. text message or email), as part of a reminder for the event, etc.) such as e.g. that the meeting room is on the cool side so the user may want to take a sweater, that the meeting room is on the warm side so the user may want to take some water, that the meeting room is noisy so the user may want to sit close to presenter, or that no one is taking an elevator to the meeting and that everyone is taking stairs so the user may want to leave a few minutes early.

Furthermore, knowledge about the user may be leveraged. For example, the calendar may leverage knowledge of favorite places and/or activities of the user to suggest what to do or where to go in between appointments. E.g., if the user needs to take her child to two doctor appointments that are scheduled three hours apart, that may translate to a “free time” of one to one and a half hours in between appointments. The calendar may look at the route she will most likely take and suggest a late lunch at a favorite restaurant of the user. As another example, the calendar application may identify several Wi-Fi-enabled locations where the user could get some work done between the two appointments. As yet another example, the calendar may know that the user is very interested in landscape paintings and suggest a visit to a gallery that is open during her free time. Also, the calendar may know that a favorite running route for the user is nearby and suggest a short run along the route. The calendar also could look at the location of the appointments, predict free-time between them, and suggest to the user (e.g. via a UI presented on a display) that there is not time to return to the office and instead begin a dialog with the user about what to do with the in-between time (e.g. prompts providing options such as going on the run discussed above).

Present principles may also use and/or predict modes of transportation and time of day. E.g., the calendar may provide fields for “mode of transport” (e.g. when the user is creating an entry) so that travel by car, bike, foot, and public transit such as a bus or subway may be recommended and/or accounted for. As time goes by, the calendar would become fairly adept at knowing how long it takes to transit certain, or similar, routes using various types of transport. The calendar could also leverage third party applications that can provide assistive information as well. For example, the application itself might be a Google “Mazer,” or access public information about public transit routes or typical traffic flow patterns for public roads. This type of information can then be used to estimate travel time. For example, it may be determined and/or predicted that a trip by car from work to school on a Tuesday might take twenty minutes at 10:00 a.m., but forty five minutes at 5:00 p.m. As another example, it may be determined and/or predicted that a five mile run which traverses two busy roads could take forty five minutes at 7:00 a.m. but fifty five minutes at noon.

Still further, it may also be appreciated that a calendar application undertaking present principles may assign probabilities to appointments. As an example, the calendar may use outside weather information to predict if appointments will be kept or not, and accordingly change the probability of there being free time. E.g., if chance of rain increases from ten percent to eighty percent, then the calendar may determine that the probability of taking the scheduled afternoon run is low, and thus the probability of converting busy time to free time increases. At that point the calendar may allow wait-listing of appointment requests for just this consideration (e.g. provide recommendations of wait-listed appointments that can be attended).

Also, probabilities of keeping appointments could also be assigned by computing a “track record” for each meeting attendee. For example, with plural calendar applications undertaking present principles which are each associated with a different meeting attendee, one person's calendar (e.g. or that of another meeting attendee on their behalf) could skew (e.g. automatically by learning the person's habits and propensities) the meeting time as it appears on that person's calendar so this person, whom may be habitually late, is told one start time for a meeting by their calendar that in actuality begins e.g. ten minutes later as e.g. represented on everyone else's calendars. As another example involving such a habitually late person, every other meeting attendee's calendar may indicate a e.g. flexible time window on their calendars while the late person's calendar shows a fixed time. As yet another example involving the habitually late person, if this person is late and a meeting time is extended beyond its scheduled and/or predicted conclusion, future meeting entries in other's calendars that involve the same late person may account for and/or predict that the next meeting will extend beyond when it would otherwise conclude.

Providing but one more example involving a calendar application undertaking present principles, if a user is driving around and the calendar accesses information that it and other devices are not undergoing much acceleration on the same road in the same area (e.g. based on information from respective inertial sensors on each device), the calendar may determine that the user is in a traffic jam. Thus, if a calendar application determines that a user is going to be late to a meeting in a big room that is filling up quickly (e.g. as may be determined based on data from the devices of other people that provide such data), a message may be provided to the user of the calendar to bring binoculars because she otherwise may not be able to see to the front of the room.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a carrier wave and/or a signal per se.

While the particular REPRESENTING IN AN ELECTRONIC CALENDAR TRAVEL TIME TO AND FROM AN EVENT is herein shown and described in detail, it is to be understood that the subject matter which is encompassed by the present application is limited only by the claims.

What is claimed is:

1. A first device, comprising:
a processor; and
a memory accessible to the processor and bearing instructions executable by the processor to:
establish a first entry in an electronic calendar for a first event based on a first date and a first time;
determine, based at least partially on the first date and the first time, a second date and a second time during which a second entry in the electronic calendar pertaining to an in-person meeting cannot be established.

2. The first device of claim 1, wherein the first date and the second date are the same date, and wherein second time is adjacent the first time.

3. The first device of claim 1, wherein the instructions are executable to:
determine, based at least partially on the first date and the first time, the second date and the second time during which any entry in the electronic calendar pertaining to any event cannot be established.

4. The first device of claim 1, wherein the determination is made at least in part based on a prediction of travel time from a first location to a second location, wherein the second location is a location at which the first event is to occur.

5. The first device of claim 4, wherein the first location is a location at which the first device is currently located.

6. The first device of claim 4, wherein the first location is a location at which the first device is predicted to be located at a time before the first date and first time.

7. The first device of claim 1, wherein the determination is made at least in part based on a prediction of travel time from a first location to a second location, wherein the first location is a location at which the first event is to occur.

8. The first device of claim 7, wherein the second location is a location at which the first device is predicted to be located at a time after the first date and first time.

9. The first device of claim 7, wherein the second location is a location at which a second event is to occur that is subsequent to the first event.

10. The first device of claim 1, wherein the instructions are executable to:
predict a mode of transportation between a first location at which the first event is to occur and a second location;
wherein the determination is based at least partially on the first date and the first time, and is based at least partially on the prediction of a mode of transportation.

11. The first device of claim 1, wherein the instructions are executable to:
determine whether telephonic communications can be conducted during the second date and second time.

12. The first device of claim 11, wherein the instructions are executable to:
in response to a determination that telephonic communications can be conducted during the second date and second time, create an indication presentable at a second device which accesses the calendar and which is different from the first device, the indication at least providing information that a person associated with the electronic calendar is available for telephonic communications during the second date and second time.

13. The first device of claim 12, wherein the indication provides information that the person is not available for an in-person meeting during the second date and second time.

14. A method, comprising:
estimating time to travel at least one of to an event entered in an electronic calendar and from the event indicated in the electronic calendar; and
representing the time to travel in the electronic calendar.

15. The method of claim 14, wherein the time to travel is represented in the electronic calendar by amending the entry for the event, which comprises information pertaining to a first date and first time range at which the event is to occur, to comprise the time to travel.

16. The method of claim 14, wherein the time to travel is represented in the electronic calendar at least in part by creating a partition in the electronic calendar for a time at which the time to travel is estimated to occur.

17. A computer readable storage medium that is not a carrier wave, the computer readable storage medium comprising instructions executable by a processor to:
identify information pertaining to a transit time at least one of to an event indicated in an electronic calendar and from the event indicated in the electronic calendar; and
indicate in the electronic calendar the information.

18. The computer readable storage medium of claim 17, wherein the information is indicated at least in part by one of creation of a first entry in the electronic calendar for the transit time and addition of the travel time to a second entry in the electronic calendar for the event.

19. The computer readable storage medium of claim 17, wherein the information is first information, and wherein the instructions are executable to:
identify second information pertaining to a change to the transit time; and
in response to the identification of the second information, adjust the indication in the electronic calendar to indicate the change to the transit time.

20. The computer readable storage medium of claim 17, wherein the electronic calendar is associated with a first device, and wherein the instructions are executable to:
access a data structure comprising data pertaining to past location information for the first device at past dates and past times; and
identify the information pertaining to the transit time based at least in part on at least a portion of the data.
